(19) United States
(12) Patent Application Publication
(10) Pub. No.: US 2017/0043302 A1
(43) Pub. Date: Feb. 16, 2017

(54) PERVAPORATIVE REMOVAL OF WATER FROM IONIC LIQUID MIXTURES USING IONOMERIC MEMBRANES

(71) Applicant: North Carolina State University, Raleigh, NC (US)

(72) Inventors: Peter S. Fedkiw, Raleigh, NC (US); Shengyang Huang, Raleigh, NC (US)

(21) Appl. No.: 14/824,417

(22) Filed: Aug. 12, 2015

(51) Int. Cl. B01D 71/68; B01D 61/36

(52) U.S. Cl. CPC B01D 71/68; B01D 61/362

(57) ABSTRACT

A pervaporation cell is described which may be used for the removal of water from a mixture containing an ionic liquid and water and optionally a solvent, incorporating an ionomeric membrane. A method of pervaporation using the pervaporation cell is also described.

### FIELD OF INVENTION

The disclosure provided herein relates to the removal of water from a mixture containing an ionic liquid and water and optionally a solvent, using an ionomeric membrane and a pervaporation cell.

### BACKGROUND

Ionic liquids are used to dissolve and facilitate chemical reactions involving cellulose, but can be expensive, and essentially complete recovery is most useful for efficient biomass processing. Because of the high viscosity of many ionic liquids, a solvent is also generally used in the reactions in practice. Reaction mixtures which include ionic liquids may become contaminated by reactants, by-products, and impurities during use and require purification. Exemplary contaminants include carboxylic acids, water, alkanols and salts. These contaminants may negatively affect the dissolution and/or reaction of cellulose and generally are removed prior to further use.

Pervaporation is a processing method used to separate mixtures of liquids by selective vaporization of a component (or components) through a membrane. Little is known about the processing of ionic liquid mixtures with membranes. Ionomeric membranes, including those made with sulfonated tetrafluoroethylene polymers such as Nafion® membranes, have a variety of commercial applications, including as the separator in chlor-alkali cells and polymer electrolyte membrane fuel cells. Disclosed herein are studies with an ionomeric pervaporation membrane used to remove water from mixtures containing an ionic liquid, water and optionally a solvent.

### SUMMARY

The present disclosure provides a pervaporation cell suitable for reducing the water content of a mixture containing an ionic liquid and water, which incorporates a liquid chamber having an inlet and an outlet configured to allow a liquid to pass into and out of the liquid chamber, a gas chamber having an inlet and an outlet configured to allow a gas to pass into and out of the gas chamber, and a membrane made up of an ionomeric polymer and having a permeation zone, which separates and partially defines each of the chambers.

The present disclosure also provides methods of reducing the water content of a mixture which contains an ionic liquid and water by pervaporation, incorporating the steps of placing the mixture in a pervaporation cell and pervaporating the ionic liquid mixture, thereby reducing the amount of water in the mixture relative to the amount of water present in the mixture prior to pervaporation.

Other aspects of the disclosure will become apparent by consideration of the detailed description and accompanying drawings.

### BRIEF DESCRIPTION OF THE DRAWINGS

The drawings below are supplied in order to facilitate understanding of the Description and Examples provided herein.

FIG. 1 is a schematic drawing of an exemplary pervaporation apparatus.

FIG. 2 shows photographs of an exemplary pervaporation apparatus.

FIG. 3 is a schematic drawing of an exemplary pervaporation cell.

FIG. 4 shows photographs of an exemplary pervaporation cell.

FIG. 5 illustrates the pervaporation process of an exemplary mixture of ionic liquid, solvent and water, showing transfer of the solvent and water components of the mixture into the gas phase with retention of the ionic liquid component in the liquid phase.

FIGS. 6(a)-6(b) are schematic drawings of different configurations for an exemplary pervaporation cell.

FIGS. 7(a)-7(c) are a series of photographs of a membrane used in an exemplary pervaporation cell having the configuration shown in the schematic drawing of FIG. 7(d).

FIGS. 8(a)-8(b) are photographs of two exemplary mixtures after pervaporation.

FIGS. 9(a)-9(b) are photographs of an exemplary pervaporation cell membrane before and after pervaporation.

FIGS. 10(a)-10(b) are photographs of an exemplary mixture after pervaporation. FIG. 10(a) shows the ionic liquid mixture and FIG. 10(b) shows the permeate.

FIG. 11 is graph of the effect of temperature on pervaporation results with liquid and gas flow rates of 5 and 50 mL/min, respectively, with an exemplary ionomeric membrane.

FIG. 12 is a graph of the water content over time of a mixture during an exemplary pervaporation process.

### DETAILED DESCRIPTION

A variety of membranes were used in a pervaporative process to remove water from a mixture containing an ionic liquid, a solvent and water. Pervaporation temperature and gas-sweep rate are variables which can be optimized for efficient pervaporation. Higher temperatures, although not high enough to affect the integrity of the ionic liquid, and higher flow rates result in larger water and solvent fluxes. Additional membrane mechanical stability can be provided by the use of gaskets to accommodate membrane swelling and a porous support layer.

Among the membranes examined, a Nafion® composite membrane was found to provide high water and solvent fluxes. Tributylmethylammonium dimethylphosphate and N-methyl-2-pyrrolidone (NMP) were the exemplary ionic liquid and solvent used for these studies, respectively. The reduction of water content in the mixture was analyzed, and the water content of a mixture of ionic liquid, NMP and water was reduced from about 1 to less than or about 0.8 wt % water. This study shows that pervaporation is useful for an ionic liquid recovery process to reduce the water content of ionic liquid mixtures.

Before any embodiments of the invention are explained in detail, it is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof, as well as additional items.

It also should be understood that any numerical range recited herein includes all values from the lower value to the upper value. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this application.

It should be understood that, as used herein, the term “about” is synonymous with the term “approximately.” Illustratively, the use of the term “about” indicates that a value includes values slightly outside the cited values. Variation may be due to conditions such as experimental error, manufacturing tolerances, and variations in equilibrium conditions. In some embodiments, the term “about” includes the cited value plus or minus 10%. In all cases, where the term “about” has been used to describe a value, it should be appreciated that this disclosure also supports the exact value.

Reference throughout this specification to “one embodiment,” “an embodiment,” or similar language means that a particular feature, structure, or characteristic described in connection with the embodiment is included in at least one embodiment of the invention provided herein. Thus, appearances of the phrases “in one embodiment,” “in an embodiment,” and similar language throughout this specification may, but do not necessarily, all refer to the same embodiment.

Furthermore, the described features, structures, or characteristics of the methods and compositions provided herein may be combined in any suitable manner in one or more embodiments. In the following description, numerous specific details are provided, to provide a thorough understanding of embodiments. One skilled in the relevant art will recognize, however, that the embodiments may be practiced without one or more of the specific details, or with other methods, components, or materials. In other instances, well-known structures, materials, or operations are not shown or described in detail to avoid obscuring aspects of the embodiments.

Exemplary embodiments of the present disclosure are provided in the following examples. The examples are presented to illustrate the inventions disclosed herein and to assist one of ordinary skill in making and using the same. These are examples and not intended in any way to otherwise limit the scope of the inventions disclosed herein.

### EXAMPLES

Ionomeric membranes made with a sulfonated tetrafluoroethylene-based polymer, including Nafion® membranes, were employed in these studies. Nafion® is an example of ionomeric material which is a copolymer of sulfonylfluoride vinyl ethers and tetrafluoroethylene, which is subsequently hydrolyzed to the sulfonate form. The ionomers made with a sulfonated tetrafluoroethylene-based backbone, including those having the general chemical structure shown below, are useful for chlor-alkali cells and polymer electrolyte membrane fuel cells, due to their high chemical and mechanical stability.

The chemical structure of a copolymer made of sulfonylfluoride vinyl ethers and tetrafluoroethylene is:

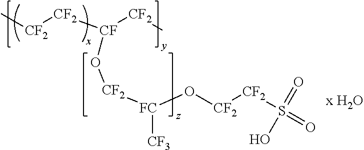

As used herein, the term “sulfonated tetrafluoroethylene-based polymer” includes any polymer or copolymer made with a fluorinated alkylene backbone, which has at least one sulfonate group attached thereto. There may be a fluorinated vinyl ether-derived group present in addition to the sulfonate group and the tetrafluoroethylene backbone, as shown in the chemical structure above. The term includes polymers or copolymers made from fluorinated ethylene or other C₂-C₆ alkenes which may be branched or straight, which may have all of the alkene hydrogens replaced with fluorine (i.e. fully halogenated) or only a portion thereof (i.e. partially halogenated).

The sulfonated tetrafluoroethylene-based polymer may be a component in a blend of polymers (i.e. a copolymer, as shown above), and may have included with it a porous meshwork or grid made of another polymer, such as PTFE, or a non-polymeric material, such as a glass fiber, ceramic or metal. The porous meshwork or grid may support and/or reinforce the membrane. Such a porous support may be incorporated with the ionomeric polymer, or it may be separate from the ionomeric polymer.

Chemicals and Membranes: NMP was purchased from BDH Chemicals. Potassium chloride (KCl) and Karl-Fischer reagent (HYDRANAL®-Coulomat AG) were obtained from Sigma-Aldrich. The ionic liquid (IL) used herein was tributylmethylammonium dimethylphosphate, provided by Eastman Chemical Company. Six commercially available ionomeric sulfonated tetrafluoroethylene membranes were evaluated, all of which were Nafion®-based membranes (Ion Power). Table 1 summarizes properties of the membranes. Membranes with thicknesses ranging from 20 to 183 μm (approx. 0.8 to about 8 mil) are divided into three types based on composition: (1) plain (neat) Nafion®, (2) fiber-reinforced Nafion®, and (3) composite (Nafion®+other polymeric material).

TABLE 1
Ionomeric Membranes Evaluated in this Study

| | | | Thickness^{&} | EW* |
|---|---|---|---|---|
| Membrane | Manufacturer | Type | (μm) | (g) |
| N117 | Ion Power | Plain | 183 | 1100 |
| N115 | Ion Power | Plain | 127 | 1100 |
| NR212 | Ion Power | Plain | 51 | 1100 |
| N324 | Ion Power | Reinforced^{$} | 152 | 1100/1500 |
| XL | Ion Power | Composite | 27 | NA |
| HP | Ion Power | Composite | 20 | NA |

^{&}Thickness data are provided by manufacturers.
*EW: Equivalent weight is defined as the weight of Nafion ® per mole of sulfonic acid.
^{$}N324 membrane contains PTFE fiber reinforcement.
NA: Not available.

As-received membranes were in proton form (H+) and were used without pretreatment. Two plain Nafion® membranes, N115 and N117, were also studied with K+ as the counterion. These membranes were prepared by ion exchange in a 1M KCl solution at room temperature for approximately 24 h. After KCl treatment, the membranes were rinsed with deionized water and soaked in deionized water overnight.

An ionomeric polymer is made with repeating polymeric units, a fraction of which are ionized with the remainder being electrically neutral. In some embodiments, the membrane comprises an ionomeric polymer which is a cation-exchange polymer, such as a sulfonated tetrafluoroethylene-based polymer. In further embodiments, the ionomeric polymer is an anion-exchange polymer.

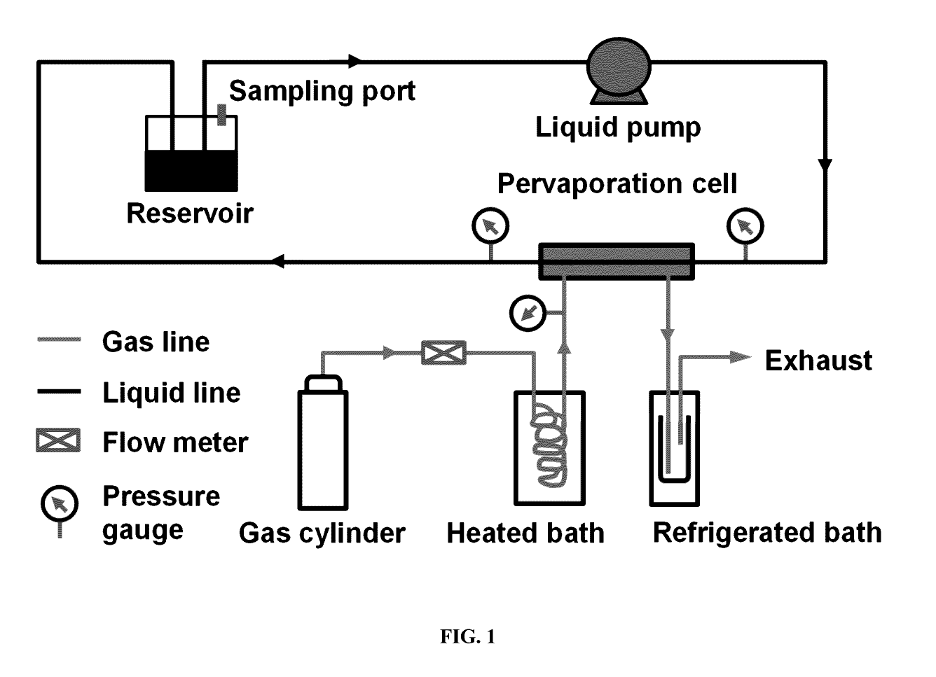

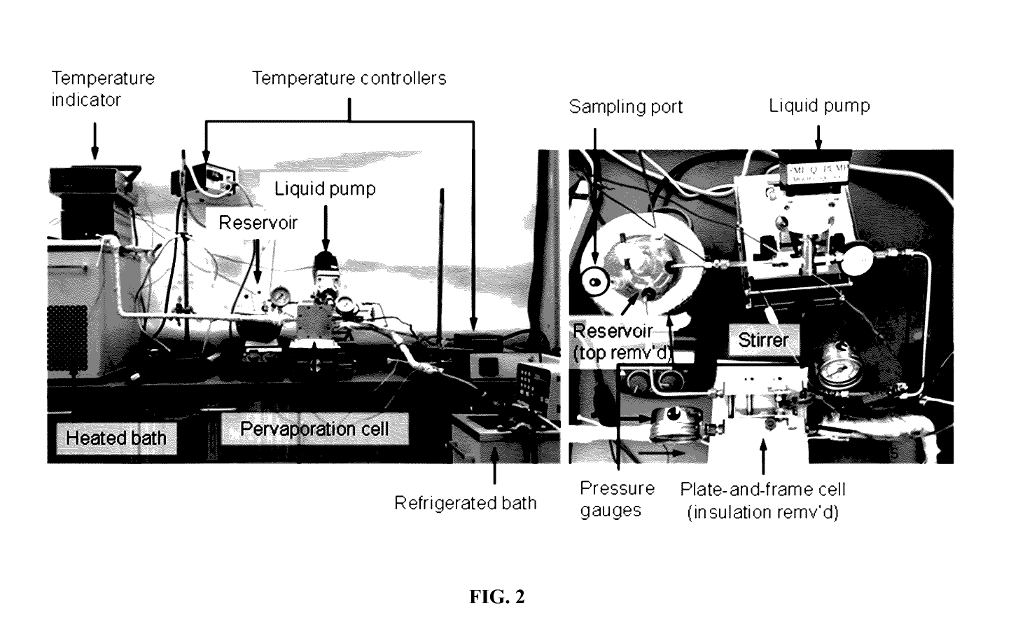

Pervaporation can separate mixtures of liquids by selective vaporization of certain components within the mixture through a membrane. Pervaporation membranes may exhibit their selectivity based upon differences in vapor pressure of the components, or may be selective based on other characteristics of the components, such as polarity or size. FIG. 1 is a schematic view of an apparatus which is suitable for pervaporation of a mixture containing an ionic liquid, water and a solvent, in which components of the mixture are selectively vaporized across an ionomeric membrane based upon their vapor pressure, thereby removing water from the ionic liquid. FIG. 2 shows photographs of the pervaporation apparatus used specifically for the studies discussed herein.

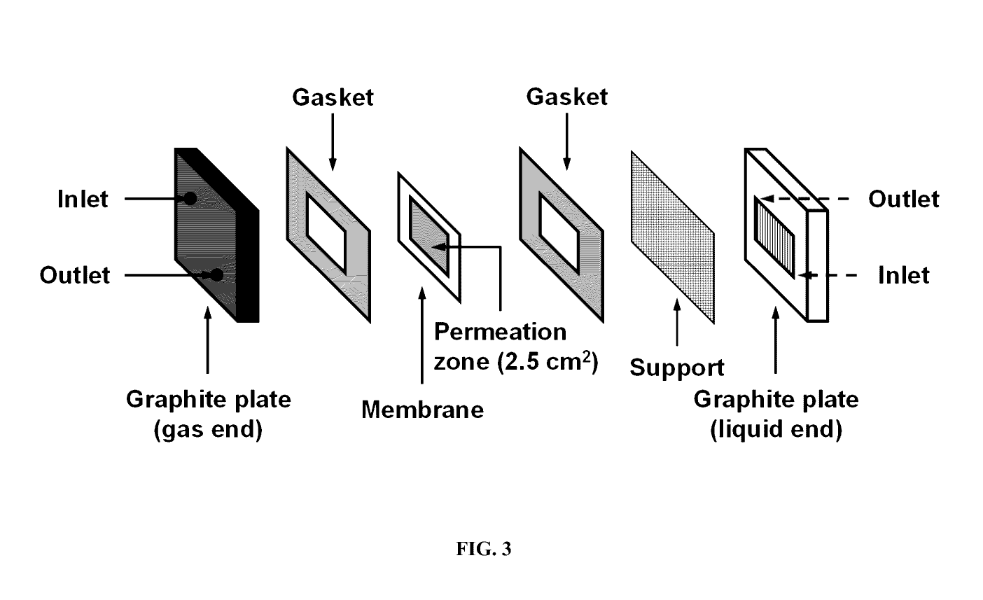

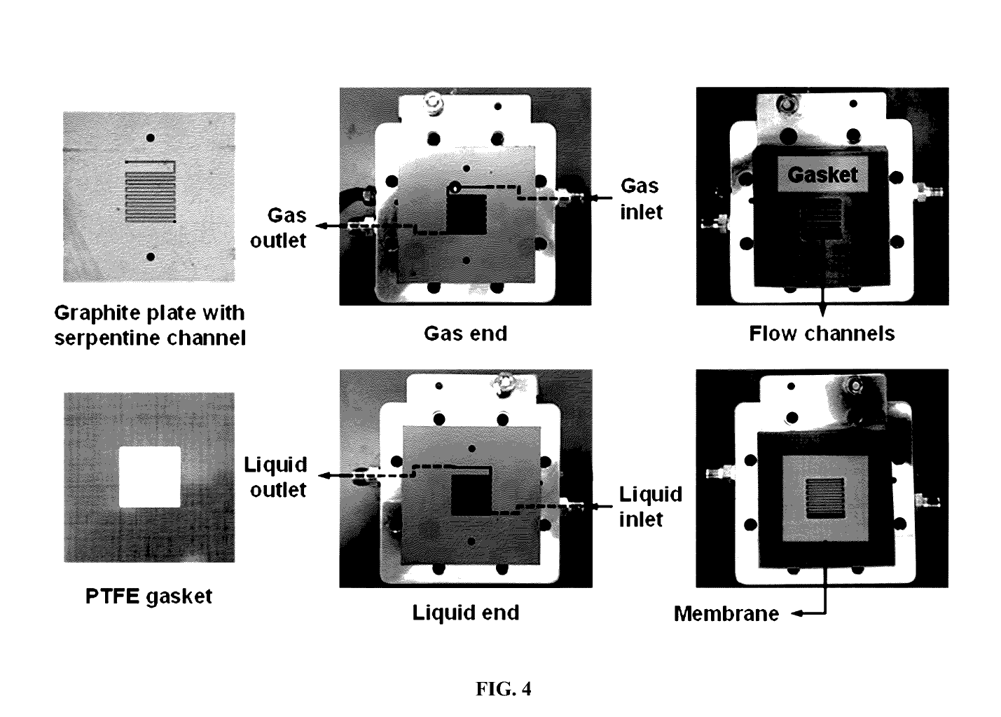

The pervaporation apparatus includes a pervaporation cell. The plate-and-frame cell used in these studies is shown in more detail in schematic form in FIG. 3. FIG. 4 shows photographs of the pervaporation cell used specifically for the studies discussed herein. As shown in FIG. 3, the cell can have a sandwich-type structure and can include two graphite plates with flow channels for liquid and gas flows, two gaskets for accommodating membrane swelling and providing a seal between graphite plate and membrane, a porous support layer to improve membrane stability, and an ionomeric membrane.

In some embodiments, the plates may be made of a material other than graphite, such as glass or polytetrafluoroethylene. The plates and cell may be made of any material which is stable or inert to the mixture placed inside. The plates have an inlet and an outlet that are configured in a manner to allow the liquid and gas to flow into the cell, expose the liquid or gas to the membrane, and flow out of the cell.

In certain embodiments, there are no gaskets present in the cell. In alternative embodiments, there are at least one, at least two, or two or more gaskets present in the cell. A gasket may have a thickness of between about 10 mil and about 50 mil, such as about 30 mil. In an embodiment, gaskets may be placed directly next to each other in the sandwich-type structure depicted in FIG. 3. The gasket may be made of any material which is stable or inert to the mixture placed inside, such as polytetrafluoroethylene.

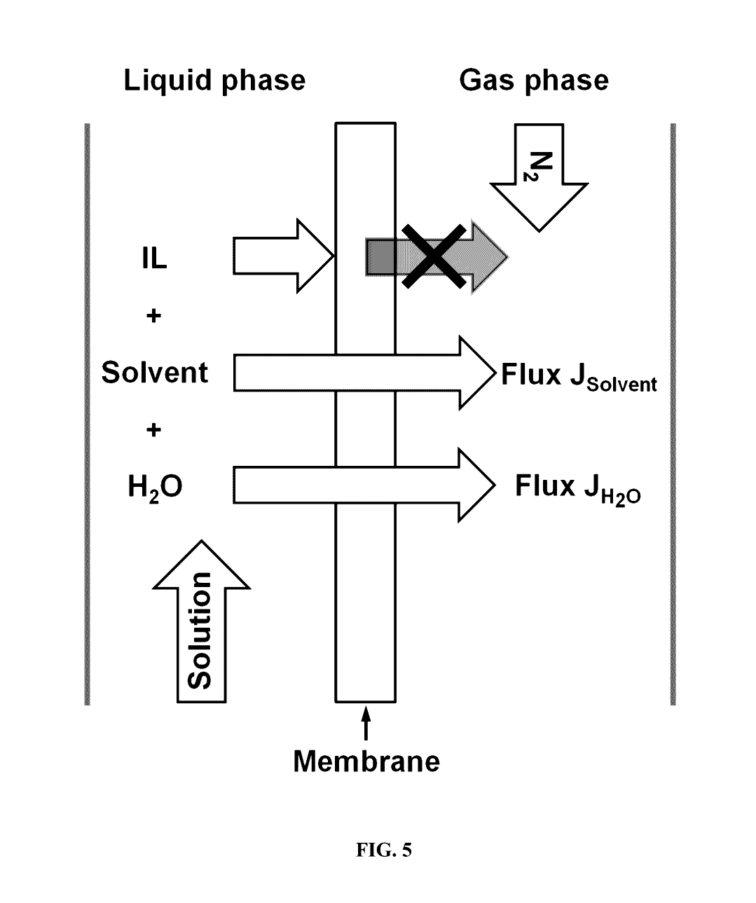

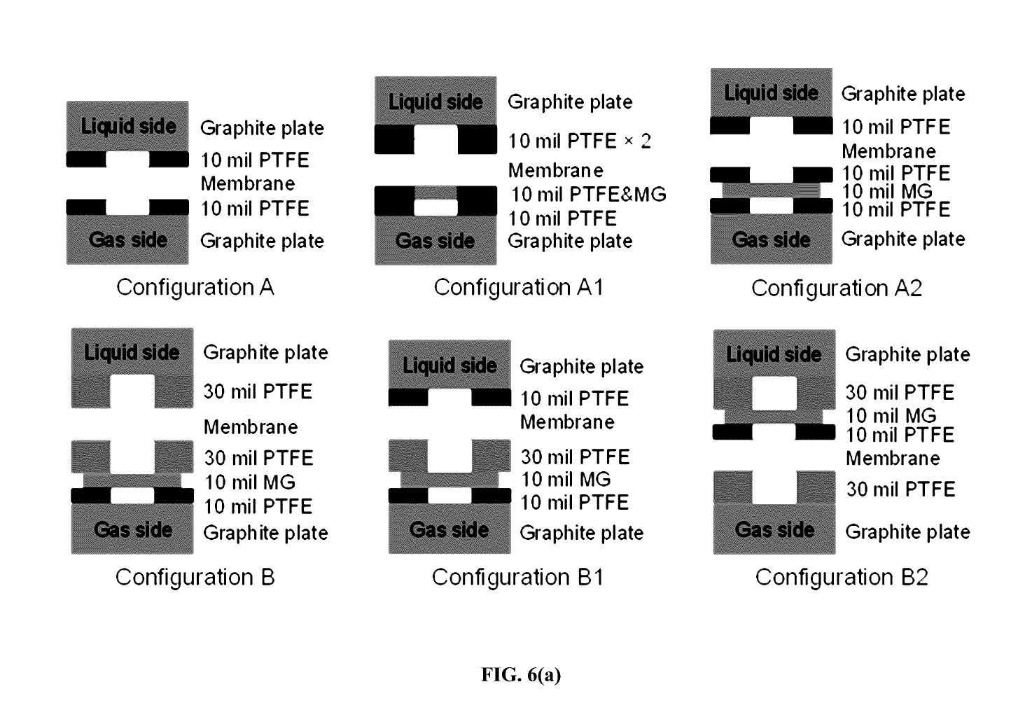

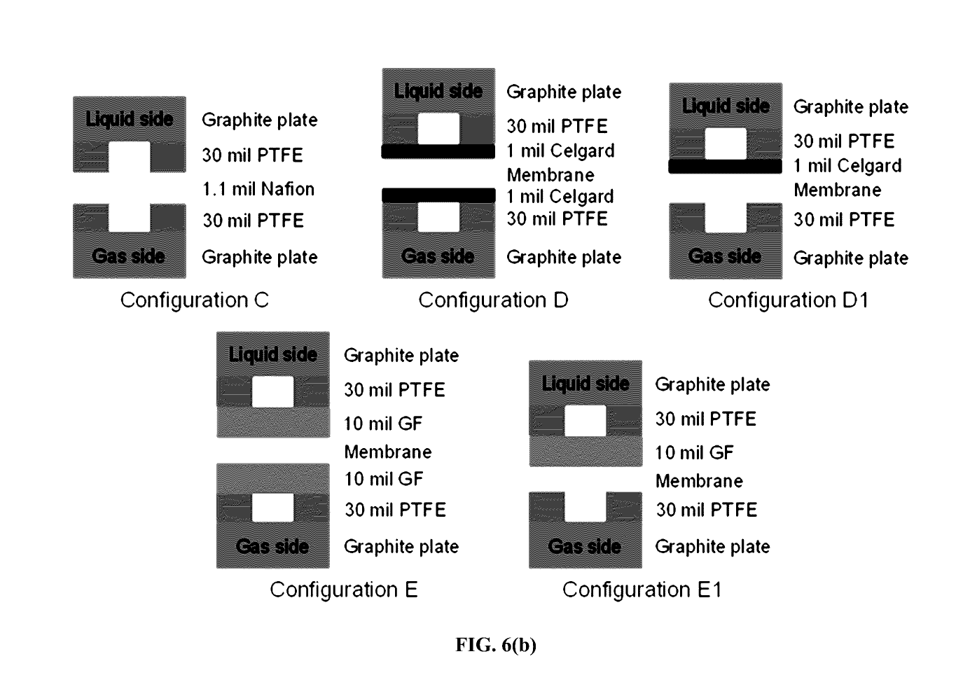

The cell may be divided into two chambers separated by the membrane, as depicted in FIGS. 5 and 6, with one chamber containing liquid and the other chamber containing gas. The plates may be placed at the end of the chamber partially defined by the membrane, to form an end plate. In an embodiment, the liquid chamber is at least partially defined by a liquid end plate and the gas chamber is at least partially defined by a gas end plate.

A porous support may be included in the pervaporation cell in the sandwich-style structure, as is shown in FIG. 3. The support may be made of any material which is stable or inert to the mixture placed inside, such as a glass fiber, polytetrafluoroethylene, ceramic or metal. In certain embodiments, the porous support is a rigid porous support. In an embodiment, a porous support is positioned between the membrane and the liquid end plate in the pervaporation cell. In some embodiments, the cell does not include a porous support.

In FIG. 5, the liquid chamber contains the ionic liquid, solvent and water and is labeled as the liquid phase side of the membrane. Similarly, the gas chamber contains gaseous nitrogen and is labeled as the gas phase side of the membrane. The solvent and water which pervaporates across the membrane from the liquid phase side to the gas phase side is indicated by the arrows labeled Flux Jₛₒₗᵥₑₙₜ and Flux J_{water}, respectively. The amount of solvent which vaporizes and goes through the membrane over time is the solvent flux (Jₛₒₗᵥₑₙₜ), and the amount of water which vaporizes and goes through the membrane over time is the water flux (J_{water}).

In some embodiments, the liquid and gas flows are parallel with each other along the membrane, and in alternative embodiments, the flows are opposite each other. In an embodiment, the gas used for the gas phase is nitrogen.

The liquid phase may be any ionic liquid which contains water, and may optionally also include a solvent. Exemplary solvents are those which are miscible with ionic liquids, such as N-methyl-2-pyrrolidone (NMP), dimethylformamide (DMF), tetrahydrofuran (THF), 1-ethyl-3-methyl-imidazolium acetate, dimethyl sulfoxide (DMSO), and alcohol solvents.

The ionic liquid may be any which is practical for pervaporation, such as those which are liquid at ambient temperature. The ionic liquid should not have a decomposition temperature below the temperature of the pervaporation unless reduced pressure is used for the process. The cation of the ionic liquid may be a substituted or unsubstituted imidazolium, pyridinium, pyrrolidinium, ammonium or phosphonium ion. The anion may be a substituted or unsubstituted halogen, tetrafluoroborate, hexafluorophosphate, triflate, tosylate, formate or alkylphosphate ion. In an embodiment, the ionic liquid is a tetraalkylammonium dialkyl phosphate, such as tributylmethylammonium dimethylphosphate. In certain embodiments, the ionic liquid is a 1-alkylpyridinium chloride, 1-butyl-3-methylimidazolium chloride, or 1-ethyl-3-methyl-imidazolium (EMIM) acetate. In further embodiments, there is more than one ionic liquid present in the mixture.

The weight ratio of ionic liquid to solvent in the mixture can vary. In an embodiment, the weight ratio of ionic liquid:solvent is between about 9:1 and about 1:9, or betwen about 1:1 and about 5:1. In certain embodiments, the ratio is about 7:3. Any weight ratio which is practical for pervaporation, such as those which provide a liquid mixture at ambient temperature, may be used.

A portion of the ionomeric membrane in the pervaporation cell is exposed to the liquid and gas chamber, and is called the permeation zone, as shown in FIG. 3. The size of the permeation zone may vary, depending upon the size of the cell. In an embodiment, the permeation zone has a surface area between about 2 cm² and about 10 cm². In certain embodiments, the permeation zone has a surface area of about 2.5 cm². In further embodiments, the permeation zone is as large as about 1 m².

The thickness of the membrane in the pervaporation cell may vary, and may be any thickness which allows for an acceptable solvent and/or water flux. In an embodiment, the membrane has a thickness between about 0.4 and about 10 mil. In certain embodiments, the membrane has a thickness of about 1 mil or no more than about 1 mil.

In an embodiment, the water flux through the membrane is at least about 6.0 mg of water per hour cm², and not more than about 100 mg of water per hour cm². In certain embodiments, the water flux is between about 1.0 and about 50.0 mg of water per hour cm²; between about 1.5 and about 20 mg of water per hour cm²; between about 2.0 and about 10.5 mg of water per hour cm²; more than 5.5 mg of water per hour cm²; or between about 6.5 and about 10.2 mg of water per hour cm².

Solution flux is the total permeate flux and includes both the water flux and solvent flux. In certain embodiments, the solution flux is between about 20 and about 250 mg of solution per hour cm²; between about 90 and about 200 mg of solution per hour cm²; more than 50 mg of solution per hour cm²; or between about 93 and about 192 mg of solution per hour cm².

Pervaporation experiments were performed in a closed-loop system consisting of an IL-mixture reservoir (165 mL in volume), a liquid pump, a flat-sheet membrane in a plate-and-frame cell (2.5 cm² permeation zone), and a dry gas (N₂) as extractant. The pervaporation cell was operated in differential-conversion mode. All gas and liquid lines were heat-tape traced and temperature controlled. A heating mantle set the temperature of the IL-solution reservoir and a cartridge heater maintained temperature of the plate-and-frame cell.

Using Karl-Fisher titration (Mettler-Toledo, KF coulometer DL 39), the water content of the IL solution was measured during the course of a batch run, and the water content of the permeate (condensate from refrigerated bath) was measured at the end of a run.

An initial screening of various pervaporation processes was performed. The variables explored included the cell configuration, the membrane type, liquid and gas flow rates, and the temperature. The cell configurations varied the presence of, and thickness of, gaskets and a porous support added to the pervaporation cell, using the 11 different cell configurations shown in FIGS. 6(a)-6(b).

In an embodiment, the liquid flow rate is between about 3 to about 75 mL/min. In some embodiments, the gas flow rate is between about 50 to about 200 mL/min. The temperature of the pervaporation process, in certain embodiments, is between about 50° C. and about 120° C. In further embodiments, the temperature is between about 60° C. and about 100° C.

The data from the initial screening studies is summarized below in Table 2.

TABLE 2
Pervaporative Removal of Water With Ionomeric Membranes

| | | | Liquid | Gas | | | Initial Water | Final Water |
|---|---|---|---|---|---|---|---|---|
| | Membrane | Temp | Flow Rate | Flow Rate | Cell | | Content | Content |
| Run | Type^{$} | (° C.)* | (mL/min) | (mL/min) | Config^{&} | Comment | (wt %) | (wt %) |
| 1 | N115 | 80 | 38 | 150 | A | System | ND^{#} | ND^{#} |
| | | | | | | leaked | | |
| 2 | N115 | 80 | 38 | 150 | A | System | ND^{#} | ND^{#} |
| | | | | | | leaked | | |
| 3 | N115 | 80 | 38 | 150 | A | System | 0.92 | 1.44 |
| | | | | | | leaked | | |
| 4 | N115 | 80 | 75 | 150 | A | Membrane | 1.73 | 2.59 |
| | | | | | | leaked | | |
| 5 | N115 | 80 | 38 | 150 | A | System | 1.76 | 2.28 |
| | | | | | | leaked | | |
| 6 | N115 | 80 | 38 | 150 | A | System | ND^{#} | ND^{#} |
| | | | | | | leaked | | |
| 7 | N115 | 80 | 75 | 150 | A | System | 1.10 | 1.11 |
| | | | | | | leaked | | |
| 8 | N115 | 80 | 75 | 150 | A | System | 1.06 | 1.05 |
| | | | | | | leaked | | |
| 9 | NR212 | 80 | 75 | 150 | A | Membrane | ND^{#} | ND^{#} |
| | | | | | | leaked | | |
| 10 | N117 | 80 | 75 | 150 | A | System | 1.56 | 1.46 |
| | | | | | | leaked | | |
| 11 | N115 | 80 | 75 | 150 | A | Membrane | 1.05 | 1.13 |
| | | | | | | leaked | | |
| 12 | N115 | 80 | 38 | 150 | A | Membrane | 1.39 | 1.33 |
| | | | | | | leaked | | |
| 13 | N117 | 80 | 38 | 150 | A | Membrane | 1.03 | 1.03 |
| | | | | | | leaked | | |
| 14 | N117 | 80 | 10 | 150 | A | Membrane | 1.06 | 0.61 |
| | | | | | | leaked | | |
| 15 | N115 | 80 | 5 | 50 | A | Membrane | 1.16 | 0.60 |
| | | | | | | leaked | | |
| 16 | N117 (K+) | 80 | 5 | 50 | A | Heating | ND^{#} | ND^{#} |
| | | | | | | tape | | |
| | | | | | | malfunction | | |
| 17 | N115 (K+) | 80 | 5 | 50 | A | Membrane | 1.07 | 0.47 |
| | | | | | | leaked | | |
| 18 | TT-070 | 80 | 3 | 50 | NA | Membrane | 1.09 | 0.88 |
| | | | | | | leaked | | |
| 19 | N324 | 80 | 5 | 50 | A | Membrane | 1.07 | 1.05 |
| | | | | | | leaked | | |
| 20 | N324 | 80 | 5 | 50 | A | Membrane | 1.30 | 1.00 |
| | | | | | | leaked | | |
| 21 | N117 (K+) | 80 | 5 | 50 | A | Membrane | 1.10 | 0.80 |
| | | | | | | leaked | | |
| 22 | N115 | 80 | 5 | 50 | A1 | Membrane | 1.00 | 0.93 |
| | | | | | | leaked | | |
| 23 | N115 | 80 | 5 | 50 | B | Membrane | 1.11 | 0.43 |
| | | | | | | was intact | | |
| 24 | NR212 | 80 | 5 | 50 | B | Membrane | 1.17 | 1.00 |
| | | | | | | leaked | | |
| 25 | N115 | 80 | 10 | 50 | B | Membrane | 1.07 | 0.40 |
| | | | | | | was intact | | |
| 26 | XL | 80 | 5 | 50 | B | Membrane | 1.10 | 0.53 |
| | | | | | | was intact | | |
| 27 | XL | 80 | 5 | 50 | B | Membrane | 1.01 | 0.34 |
| | | | | | | was intact | | |
| 28 | none | 80 | 0 | 0 | — | Control | 1.25 | 1.12 |
| | | | | | | experiment | | |
| 29 | XL | 60 | 5 | 50 | C | Membrane | 1.05 | 0.85 |
| | | | | | | was intact | | |
| 30 | XL | 100 | 5 | 50 | B | Membrane | 1.16 | 0.72 |
| | | | | | | leaked | | |
| 31 | XL | 90 | 5 | 50 | B | Membrane | 1.11 | 0.37 |
| | | | | | | was intact | | |
| 32 | XL | 90 | 5 | 50 | B | Membrane | 0.97 | 0.25 |
| | | | | | | was intact | | |
| 33 | XL | 95 | 5 | 50 | B | Membrane | 0.98 | 0.33 |
| | | | | | | leaked | | |
| 34 | HP | 80 | 5 | 50 | B | Membrane | 1.03 | 0.46 |
| | | | | | | was intact | | |
| 35 | HP | 80 | 5 | 50 | B | Membrane | 1.01 | 0.41 |
| | | | | | | leaked | | |
| 36 | XL | 90 | 5 | 50 | A2 | Membrane | 1.01 | 0.29 |
| | | | | | | leaked | | |
| 37 | XL | 90 | 5 | 50 | B1 | Membrane | 1.07 | 0.32 |
| | | | | | | was intact | | |
| 38 | XL | 90 | 5 | 50 | D | Membrane | 1.02 | 0.52 |
| | | | | | | was intact | | |
| 39 | XL | 100 | 5 | 50 | D | Membrane | 1.01 | 0.56 |
| | | | | | | was intact | | |
| 40 | XL | 100 | 5 | 50 | E | Membrane | 0.99 | 0.47 |
| | | | | | | leaked | | |
| 41 | XL | 90 | 5 | 50 | E | Membrane | 1.01 | 0.62 |
| | | | | | | leaked | | |
| 42 | XL | 100 | 5 | 50 | B2 | Membrane | 1.01 | 0.36 |
| | | | | | | was intact | | |
| 43 | XL | 100 | 5 | 50 | B2 | Membrane | 0.98 | 0.49 |
| | | | | | | was intact | | |
| 44 | XL | 100 | 5 | 50 | D1 | Membrane | 1.00 | 0.46 |
| | | | | | | was intact | | |
| 45 | XL | 100 | 5 | 50 | E1 | Membrane | 1.00 | 0.47 |
| | | | | | | was intact | | |
| 46 | XL | 100 | 5 | 50 | B2 | Membrane | 1.04 | 0.52 |
| | | | | | | was intact | | |
| 57 | XL | 100 | 5 | 50 | B2 | Membrane | 1.00 | 0.41 |
| | | | | | | was intact | | |
| 66 | XL | 100 | 5 | 100 | B2 | Membrane | 0.99 | 0.33 |
| | | | | | | was intact | | |
| 67 | XL | 100 | 5 | 150 | B2 | Membrane | 1.04 | 0.47 |
| | | | | | | was intact | | |

^{$}Membranes are proton form unless listed otherwise in the table;
*Pervaporation temperature;
^{&}Cell configuration;
^{#}Not Determined.

The water content in the IL solution decreased linearly with time as its concentration dropped from 1 to 0.5 wt % or lower. The average mass flux of the solution over the course of the experiment was calculated using the total weight of the permeate at the end of a batch experiment. The NMP is absorbed by Nafion® and NMP is also volatile, although with a much lower vapor pressure than water; thus, NMP pervaporates in addition to water. Thus, the selectivity of the pervaporation process to water is relevant.

In general, it was found that increasing the pervaporation temperature and gas flow rate resulted in greater water and solvent fluxes. Membrane mechanical stability was improved by increasing the gasket thickness and providing a porous, more rigid support layer for the membrane, such as a polypropylene support (such as those found in Celgard® membranes), a polyethylene support, glass fiber, or a metal grid. Among the membranes and cell configurations examined, the sulfonated tetrafluoroethylene-based ionomeric XL composite membrane in the B and B2 configurations provided the lowest final water content in the mixture after pervaporation.

Water and solution flux information for the screening studies is shown in Table 3, for the experiments in which the membrane remained intact.

TABLE 3
Change in water content, water flux,
water selectivity and solution flux

| | | | | water | | solution |
|---|---|---|---|---|---|---|
| | | | | flux | | flux |
| | Membrane | Cell | Δ water | (mg per hr | water | (mg per hr |
| Run | Type^{$} | Config^{&} | (wt %) | cm²) | selectivity | cm²) |
| 23 | N115 | B | 0.68 | 3.6 | 1.6 | 47 |
| 25 | N115 | B | 0.67 | 3.1 | 1.4 | 47 |
| 26 | XL | B | 0.57 | 3.9 | 1.8 | 60 |
| 27 | XL | B | 0.67 | 3.5 | 1.2 | 75 |
| 29 | XL | C | 0.2 | 2.0 | 2.1 | 24 |
| 31 | XL | B | 0.74 | 5.5 | 1.7 | 95 |
| 32 | XL | B | 0.72 | 5.2 | 1.7 | 85 |
| 34 | HP | B | 0.57 | 2.5 | 1.6 | 42 |
| 37 | XL | B1 | 0.75 | 4.4 | 1.7 | 77 |
| 38 | XL | D | 0.50 | 2.4 | 1.2 | 52 |
| 39 | XL | D | 0.45 | 3.2 | 1.4 | 63 |
| 42 | XL | B2 | 0.65 | 7.0 | 1.8 | 116 |
| 43 | XL | B2 | 0.49 | 6.7 | 2.2 | 93 |
| 44 | XL | D1 | 0.54 | 3.9 | 1.6 | 76 |
| 45 | XL | E1 | 0.53 | 3.9 | 1.4 | 78 |
| 46 | XL | B2 | 0.52 | 6.5 | 1.9 | 115 |
| 57 | XL | B2 | 0.59 | 7.2 | 1.9 | 117 |
| 66 | XL | B2 | 0.66 | 9.6 | 1.4 | 186 |
| 67 | XL | B2 | 0.57 | 10.2 | 1.4 | 192 |

^{$}Membranes are proton form unless listed otherwise;
^{&}Cell configuration.

Among the membranes examined, the sulfonated tetrafluoroethylene-based ionomeric XL composite membrane provided the highest water (10.2 mg per hr cm²) and solution (192 mg per hr cm²) fluxes.

Table 4 compares the pervaporation results of N115 and XL membranes. Both membranes were stable during the run and were able to lower the water content from 1 to 0.5 wt with similar water fluxes. However, post-run examination revealed different membrane swelling behaviors.

TABLE 4
Effect of membrane type on pervaporation rates:
Comparison of N115 and XL Membranes*

| | Duration | Water content (wt %) | | H₂O flux | Solution flux^{$} | H₂O |
|---|---|---|---|---|---|---|
| Membrane | (h) | Initial | Final | [mg/(h · cm²)] | [mg/(h · cm²)] | selectivity* |
| N115 | 160 | 1.11 | 0.43 | 3.7 | 47 | 1.6 |
| XL | 100 | 1.10 | 0.53 | 3.9 | 60 | 1.8 |

Cell configuration B;
^{$}H₂O + NMP.
*H₂O Selectivity = (wt_{H}_{₂}_{O}/wt_{NMP})_{permeated}/(wt_{H}_{₂}_{O}/wt_{NMP})_{reservoir@t0}.

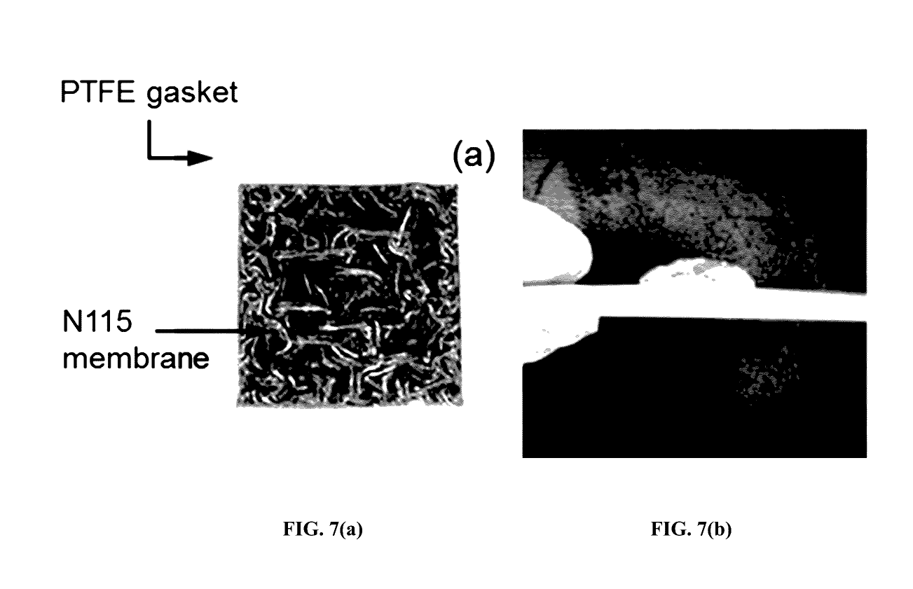

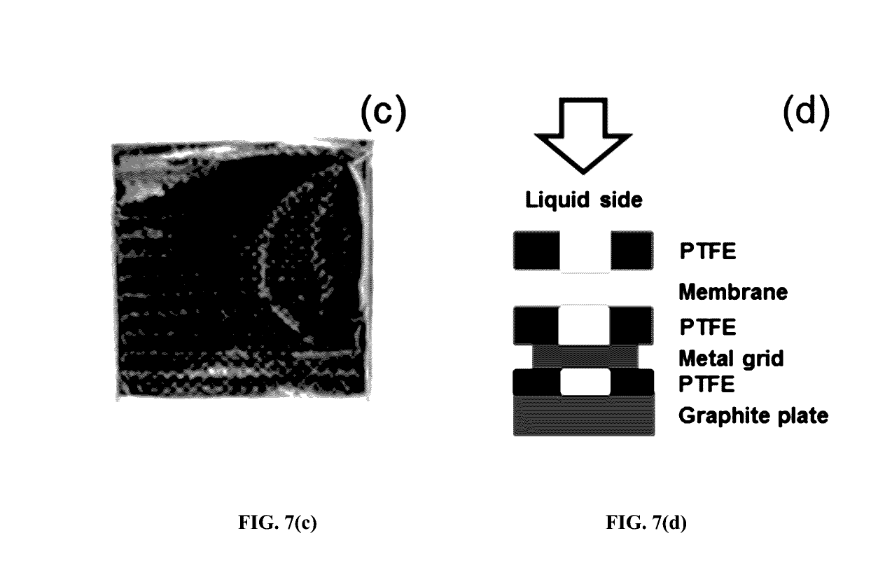

Images of the membrane after the experiments are shown in FIGS. 7(a) and 7(c), and FIG. 7(d) describes the viewpoint of these photos. Both membranes swelled toward the liquid side during pervaporation. However, N115 formed wrinkles due to severe swelling and could be easily stretched by a thumb, as shown in FIG. 7(b). FIG. 7(c) shows the XL membrane after pervaporation. Thus, a plain membrane may have poor durability and may not be suitable for long-term applications. In contrast, the XL membrane showed limited swelling and was stable during the pervaporation experiments.

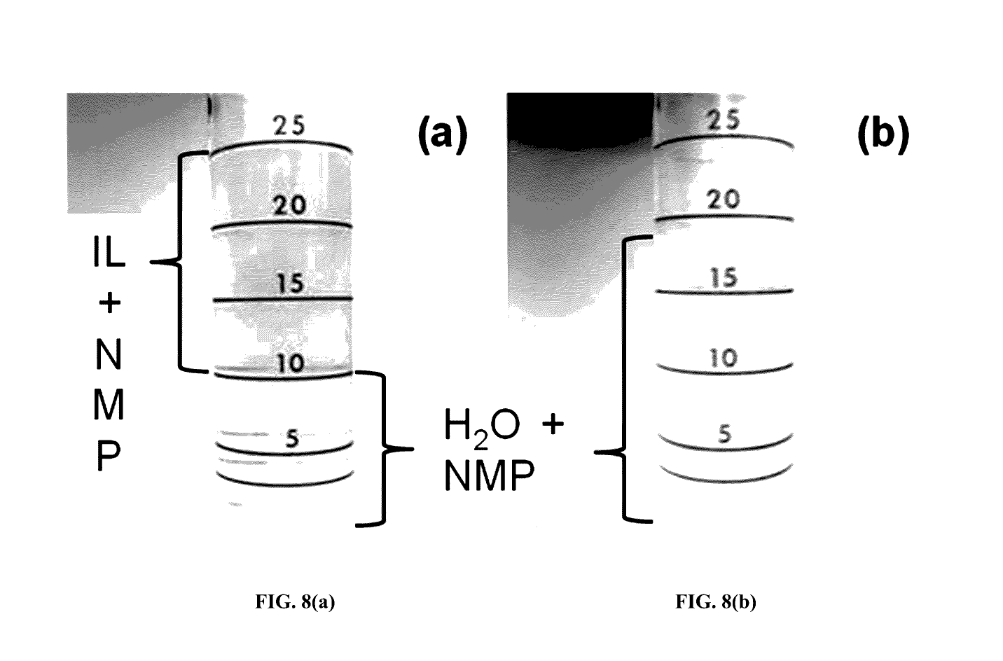

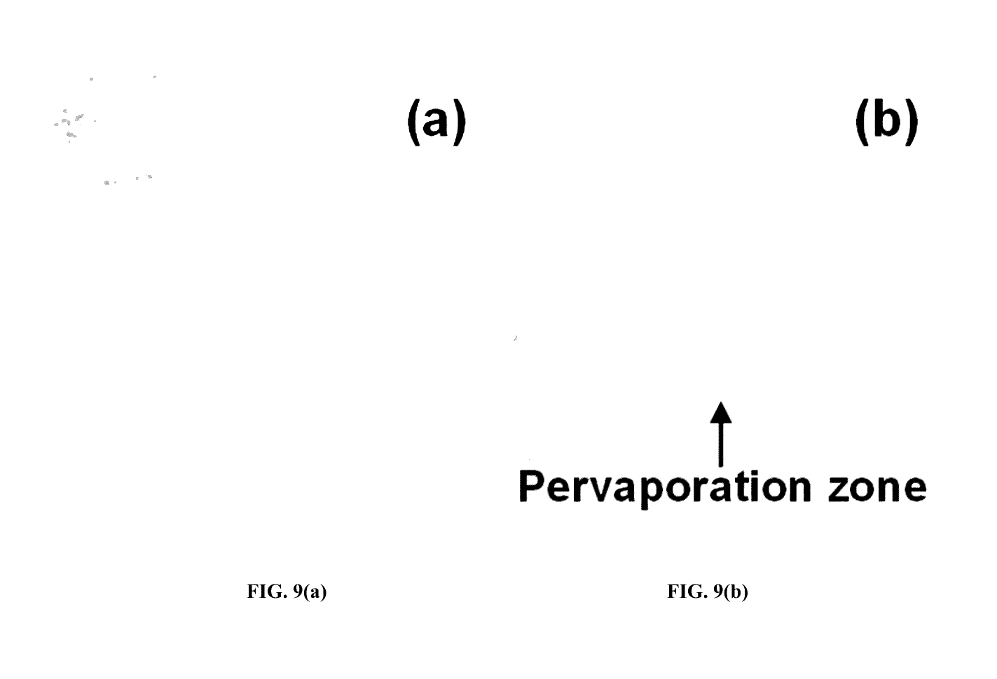

FIGS. 8(a) and 8(b) shows photos of permeated liquid for 10- and 30-mil gaskets using the N115 membrane in a C cell configuration. The top part of the permeated liquid collected using 10-mil gaskets is yellowish indicating that a significant amount of IL was present in the solution and that the membrane leaked. In contrast, the permeated liquid is clear for the run with 30-mil gaskets. These results show 30-mil gaskets accommodated the membrane swelling in the pervaporation process and prevented membrane leakage.

Subsequent experiments were performed using the B2 pervaporation cell configuration unless otherwise noted. After refining experimental protocols, a mass balance on water removed from the IL solution and collected in the permeate would typically close within ±6%.

Membrane solution-uptake studies were performed for four liquids: NMP, IL-NMP (wt ratio IL:NMP of 7:3), IL, and water at room temperature. Membrane samples (2×3 cm²) were dried at 45° C. and then soaked in the solutions at 20° C. for 24 h and 1 month. Membrane uptake was determined by measuring the weight difference of the membrane before and after immersing in the solutions.

Uptake (%) was calculated as:

$$Uptake ( \% ) = \frac{{wt}_{wet} - {wt}_{dry}}{{wt}_{dry}} \times 100 \% \qquad ( 1 )$$

where wt_{wet} and wt _{dry} are the mass of wet and dried membranes, respectively.

Membrane chemical and mechanical stability in contact with the IL-NMP-H₂O mixtures was studied before evaluating the feasibility of the pervaporation process itself Uptake results provide not only information about membrane stability but also membrane swelling behavior. Membrane (H⁺form) uptake results are summarized in Table 5.

TABLE 5
Comparison of Solution Uptake Results of Membranes
(Proton Form) at Room Temperature

| | NMP | | IL-NMP* | | IL^{$} | | H₂O | |
|---|---|---|---|---|---|---|---|---|
| Membrane^{a} | 24 h | 1 mo. | 24 h | 1 mo. | 24 h | 1 mo. | 24 h | 1 mo. |
| N115 | 56 ± 1 | 68 ± 1 | 52 ± 1 | 48 ± 1 | Ne. | 6 ± 1 | 16 ± 1 | 21 ± 1 |
| N117 | 57 ± 1 | 67 ± 1 | 44 ± 1 | 47 ± 1 | Ne. | 5 ± 1 | 25 ± 1 | 26 ± 1 |
| NR212 | 87 ± 2 | 126 ± 2 | 70 ± 1 | 62 ± 1 | Ne. | 8 ± 4 | 8 ± 1 | 16 ± 1 |
| N324 | 51 ± 1 | 53 ± 1 | 7 ± 1 | 17 ± 1 | Ne. | 2 ± 1 | 8 ± 1 | 8 ± 1 |
| XL | 82 ± 1 | 104 ± 2 | 23 ± 1 | 26 ± 1 | 6 ± 1 | 10 ± 1 | 6 ± 1 | 11 ± 1 |
| HP | 67 ± 2 | 92 ± 1 | 23 ± 1 | 27 ± 1 | 5 ± 1 | 18 ± 1 | 2 ± 1 | 6 ± 1 |

^{a}Membranes were dried at 45° C. and then soaked in solution at 20° C. for 24 h and 1 month. N = 3.
*The weight ratio between IL and NMP is 7:3.
^{$}IL contains >1% H₂O.
Ne.: Negligible.

For the plain membranes, such as N115, N117, and NR212, solution uptake decreased in following order:

NMP>IL-NMP>H₂O>IL (2)

Plain membranes showed no notable weight gain after immersion in IL for 24 h. However, the average uptake amount increased to 7% after 1 month. ILs are known to be hygroscopic and water accumulates slowly over time to saturation corresponding to the ambient humidity. Therefore, the observed increase of uptake in the membranes may be caused by water absorption into the IL from the air atmosphere to which the containers were exposed.

Nafion® membranes are chemically and mechanically stable in IL, and no sign of membrane degradation was observed during the uptake experiments. Composite membranes (XL and HP) absorbed less than 30% of their initial weight in IL-NMP solution, which indicates higher stability and limited swelling relative to the plain membranes. Moreover, composite membranes showed higher solution uptake than the plain membranes in IL and may be attributed to absorption in the polymer used in the composite.

The uptake results indicated NR212 membranes were unstable in IL-NMP: they showed weight loss after one month and other experiments showed that pinholes were formed during their use in pervaporation experiments. NMP is a common solvent used in the dispersion-cast process for synthesizing membrane such as NR212. These dispersion-cast membranes showed poor stability and slowly dissolved in IL-NMP solution during the uptake experiments.

The membrane counterion can affect the swelling behavior of ionomeric membranes, including Nafion® membranes. Two factors which may affect the uptake amount include the cation radius and cation softness (Table 6).

TABLE 6
Softness Parameters and Size of Cations

| Cation | H⁺ | Li⁺ | Na⁺ | K⁺ |
|---|---|---|---|---|
| Radius (×10³ nm) | ~0 | 60 | 95 | 133 |
| Softness parameter | 0.00 | −0.95 | −0.75 | −0.58 |

In our study, the H+ form of N115 and N117 membranes were ion-exchanged into the K+ form. The K+ form of N115 showed a factor of four decrease of the absorption of IL+NMP at room temperature from 52 to 13 wt % in comparison to the H+ form (Table 7). Similar phenomena were observed for the K+ form of N117. The uptake ability of Nafion® membranes for most solutions decreases when the membrane is in K+ form, as shown. Interestingly, both K+ forms of N115 and N117 membranes absorbed only 3% less NMP than the H+ forms of the membranes.

TABLE 7
Comparison of Solution Uptake Results of Proton (H+) and
Potassium (K+) Forms of N115 and N117 Membranes

| | NMP | | IL-NMP* | | IL^{$} | | H₂O | |
|---|---|---|---|---|---|---|---|---|
| Membrane^{a} | H⁺ | K⁺ | H⁺ | K⁺ | H⁺ | K⁺ | H⁺ | K⁺ |
| N115 | 56 ± 1 | 53 ± 1 | 52 ± 1 | 13 ± 1 | Ne. | 2 ± 1 | 16 ± 1 | 8 ± 1 |
| N117 | 57 ± 1 | 54 ± 1 | 44 ± 1 | 9 ± 1 | Ne. | 2 ± 1 | 25 ± 1 | 9 ± 1 |

^{a}N115 and N117 membranes were ion-exchanged into K⁺ form using 1M KCl. Membranes were soaked in solution at 20° C. for 24 h. N = 3.
*The weight ratio between IL and NMP is 7:3.
^{$}IL contains >1% H₂O.
Ne.: Negligible.

Pervaporation experiments were performed under differential-conversion conditions of the solution as it passed through the cell. The parameters investigated included multiple ionomeric membrane types (including K+ as the counterion for certain membranes), gas-sweep rate from 50 to 200 mL/min, and temperature from 60 to 100° C.

The water content in the IL solution decreased linearly with time as its concentration dropped from 1 to 0.5 wt % and this is the rate reported herein. The average mass flux of the permeate over the course of the experiment was calculated using the total weight of the permeate at the end of a batch experiment. The NMP is absorbed by Nafion® and NMP is also volatile, although with a much lower vapor pressure than water; thus, NMP pervaporates in addition to water. Hence, an important measure determined in the work is the selectivity of the pervaporation process to water.

A screening protocol (pervaporation performed at 80° C. with liquid and gas flow rates of 5 and 50 mL/min, respectively) was used to evaluate the membranes. It was found that, for the plain membranes, a thinner membrane provides greater permeate fluxes; the water flux data showed N115 (127 μm) has larger water flux than N117 (183 μm). It was also determined that the K+ form of Nafion® attenuated membrane swelling; however, the H+ form of Nafion® resulted in a larger water flux than the K+ form (Table 8).

TABLE 8
Effect of Membrane Thickness and Counterion on Pervaporation
Results at 80° C.: Gasket thickness is 254 μm.

| | | |
|---|---|---|
| Water content^{&} | | |
| (wt %) | Duration | H₂O flux |

| Membrane | Initial | Final | (h) | [mg/(h · cm²)] |
|---|---|---|---|---|
| N115 (H⁺) | 1.16 | 0.60 | 80* | 4.4 |
| N115 (K⁺) | 1.07 | 0.47 | 120* | 3.9 |
| N117 (H⁺) | 1.06 | 0.61 | 95* | 3.7 |
| N117 (K⁺) | 1.1 | 0.8 | 100* | 3.1 |

^{&}Karl-Fischer titration is used to determine water content.
*Run terminated due to membrane leakage.

The experiments with N115 in the K+ form showed a factor of four decrease of the absorption of IL+NMP at room temperature from 52% to 13% in comparison to the H⁺ form. Thus, pervaporation with ionomeric membranes in the K⁻ form or divalent cations may provide greater permeation rates due to their potential to electrostatically cross-link ionomers, to limit membrane swelling and improve stability.

In certain embodiments, the counterion for the ionomeric membrane is a monovalent cation. In an embodiment, the counterion is a divalent cation. For example, the counterion is selected from at least one of H+, K+, Li+, Na+, Ca++, or Mg++, or any mixtures thereof.

It was determined that the swelling of the membranes in IL-NMP mixture caused significant pressure drops in the flow channel and large trans-membrane pressure difference, this membrane swelling was accommodated in the cell design by increasing the gasket thickness (from 254 to 762 μm). The NR212 membranes were unstable in IL-NMP: they showed weight loss in static solution-uptake experiments and pinholes were formed in pervaporation experiments. The HP membrane formed an unknown surface film during the pervaporation and showed the lowest water flux at these conditions.

The pervaporation results using XL membranes were promising, showing reasonable mass fluxes, limited swelling, and good stability during pervaporation experiments. Therefore, XL membranes were chosen to examine more thoroughly the effects of temperature, support type, and gas-sweep rate on water and solvent pervaporation rates.

The effect of temperature was studied using XL membranes. The water flux increased 2.5 times to 10 mg/(h·cm²) when the cell temperature increased from 80° C. to 100° C. Despite the high water flux, a XL membrane in a cell without a membrane support was less stable and formed pinholes when the pervaporation temperature increased from 80 to 100° C. Post-run examination of the membranes indicated they swelled considerably at the higher temperature and essentially thinned to failure in an extrusion-like process.

To prevent dimensional distortion of the swollen membrane, three types of supports with various gasket arrangements were used to increase membrane stability; (1) a metal grid, (2) Celgard®, and (3) glass fiber. Table 9 summarizes pervaporation results for three cell configurations. The results indicate that a support increased membrane stability and prevents pinhole formation. The H₂O flux of cell configuration B2 with metal grid as support is 6.8 mg per h cm², which is approximately 174% of that generated when employing Celgard® (D1) and glass fiber (E1) as supports.

TABLE 9
Effect of Porous Support Types on Pervaporation Rates at 110° C.; XL

| | | | Pore size | H₂O flux | Solution flux^{$} | H₂O |
|---|---|---|---|---|---|---|
| Support | Manufacturer | Configuration* | (μm) | (mg h⁻¹ cm⁻²) | (mg h⁻¹ cm⁻²) | selectivity^{&} |
| Metal grid | Dexmet | B2 | ~5 × 10² | 6.8 | 110 | 2 |
| Celgard | Celgard | D1 | ~5 × 10⁻² | 3.9 | 76 | 1.6 |
| Glass fiber | Pall | E1 | ~1 | 3.9 | 78 | 1.4 |

*Configurations as shown in FIG. 6;
^{$}H₂O and NMP.
*H₂O Selectivity = (wt_{H}_{₂}_{O}/wt_{NMP})_{permeated}/(wt_{H}_{₂}_{O}/wt_{NMP})_{reservoir@t0}.

In an effort to reduce dimensional distortion of the swollen membrane a metal grid with a pore size of 500 μm was used as a support to improve membrane stability. The results indicated the XL membrane was stable during the pervaporation experiment at 100° C. The water content in the IL-NMP-H₂O solution decreased linearly as its concentration dropped from 1 to 0.41 wt % within a period of 56 h. The water and solution fluxes are 7.2 and 117 mg/(h·cm²), respectively, as shown in Table 10. Solution flux is the total permeate flux and indicates both water and NMP.

TABLE 10
Pervaporation Experiment Performed Using Plate-and-frame Cell and XL Membrane^{&}

| Temperature | Water content (wt %) | | Duration | H₂O flux | Solution flux^{$} | H₂O |
|---|---|---|---|---|---|---|
| (° C.) | Initial | Final | (h) | [mg/(h · cm²)] | [mg/(h · cm²)] | selectivity* |
| 100 | 1.00 | 0.41 | 56 | 7.2 | 117 | 1.9 |

^{&}Gas and liquid flow rates of 5 and 50 mL/min, respectively.
^{$}H₂O and NMP.
*H₂O selectivity = (wt_{H}_{₂}_{O}/wt_{NMP})_{permeated}/(wt_{H}_{₂}_{O}/wt_{NMP})_{reservoir@to}.

Water selectivity is listed in the last column of the Table 10 and is defined as

$${H}_{2} O selectivity = \frac{( {wt}_{{H}_{2} O} / {wt}_{NMP} ) Permeate}{( {wt}_{{H}_{2} O} / {wt}_{NMP} ) reservoir @ {t}_{0}} \qquad ( 3 )$$

where (wt_{H2O}/wt_{NMP}) reservoir@t0 is measured at time 0, and (wt_{H2O}/wt_{NMP})permeate are the mass ratio of water to NMP initially in the IL-mixture reservoir and at the end-of-run in the permeate, respectively.

During the pervaporation process, NMP permeates across the membrane, and the selectivity of the pervaporation process to water may be determined. Even though the IL solution initially contains ˜30 wt % NMP and ˜1 wt % water, the H₂O selectivity is 1.9, indicating that water more preferentially permeated through the membrane.

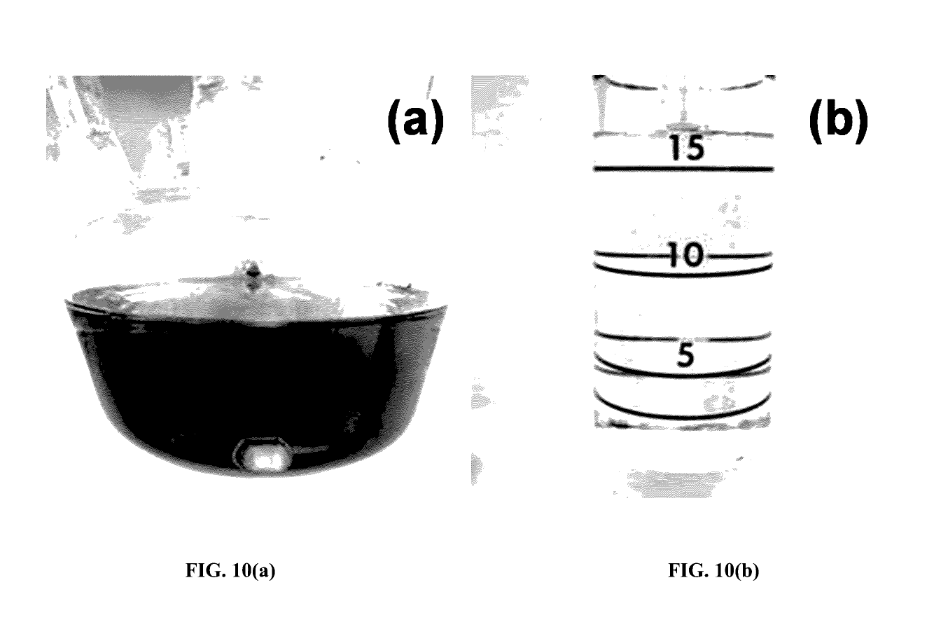

Pervaporation was performed at 100° C. with an XL ionomeric membrane and a metal grid support. The gas and liquid flow rates were 5 and 50 mL/min, respectively. FIG. 10(a) and FIG. 10(b) are images of the IL solution at the end-of-run and permeate liquid, respectively. The images show a distinct color difference: the IL-NMP-H₂O mixture is brownish and the permeate solution is clear. These images indicate the permeation of IL through the membrane is negligible. IL was confined by the membrane and remained on the liquid side of the cell. Furthermore, these results indicate that a support can improve membrane stability.

The effect of temperature on pervaporation rates was investigated using XL membranes (Table 11).

TABLE 11
Effect of Pervaporation Temperature
on Pervaporation Rate: XL Membranes^{&}

| | Temperature | H₂O flux | Solution flux^{$} | H₂O |
|---|---|---|---|---|
| Membrane | (° C.) | [mg/(h · cm²)] | [mg/(h · cm²)] | selectivity* |
| XL | 60 | 2.0 | 24 | 2.1 |
| XL^{a} | 80 | 3.7 | 68 | 1.5 |
| XL^{a} | 90 | 5.3 | 86 | 1.7 |
| XL^{a} | 100 | 6.8 | 110 | 2.0 |

^{&}Liquid and gas flow rates are 5 and 50 mL/min, respectively.
^{a}Data showed in the table are averages from at least two runs.
^{$}H₂O and NMP.
*H₂O selectivity = (wt_{H}_{₂}_{O}/wt_{NMP})_{permeated}/(wt_{H}_{₂}_{O}/wt_{NMP})_{reservoir@t0}.

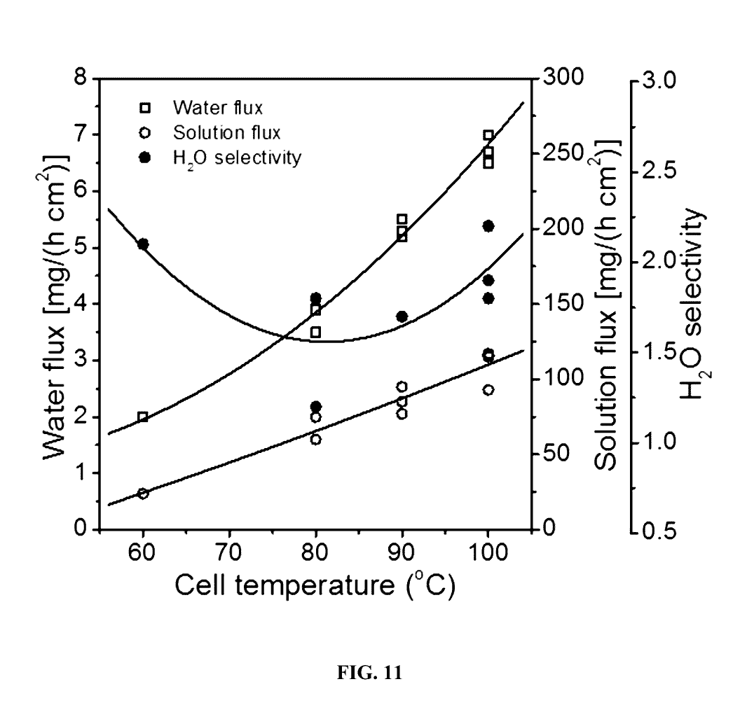

Pervaporation performances were measured from 60 to 100° C., with the upper limit set to limit IL degradation. The water and solution fluxes (H₂O and NMP) and water selectivity are shown in FIG. 11 as a function of the pervaporation temperature. The water and NMP mass fluxes using the XL membranes increased with temperature: water flux increased 3.5 times from 2 to 7 mg/(h·cm²) and solution flux increased around 5 times for XL membranes. Water selectivity shows a minimum at pervaporation temperature around 80° C. for XL membranes.

Table 12 shows pervaporation results collected using XL membranes at 100° C. for two sets of flow conditions and run times: liquid and gas flow rates of 5 and 150 mL/min for 37 hours, and 5 and 50 mL/min for 56 hours.

TABLE 12
Pervaporation Results at 100° C.

| | Duration | Water content (wt %) | | H₂O flux | Solution flux^{$} | H₂O |
|---|---|---|---|---|---|---|
| Membrane | (h) | Initial | Final | [mg/(h · cm²)] | [mg/(h · cm²)] | selectivity* |
| XL | 37 | 1.04 | 0.47 | 10.2 | 192 | 1.4 |
| XL | 56 | 1.00 | 0.41 | 7.2 | 117 | 1.9 |

^{$}H₂O + NMP.
*H₂O selectivity = (wt_{H}_{₂}_{O}/wt_{NMP})_{permeated}/(wt_{H}_{₂}_{O}/wt_{NMP})_{reservoir@t0}.

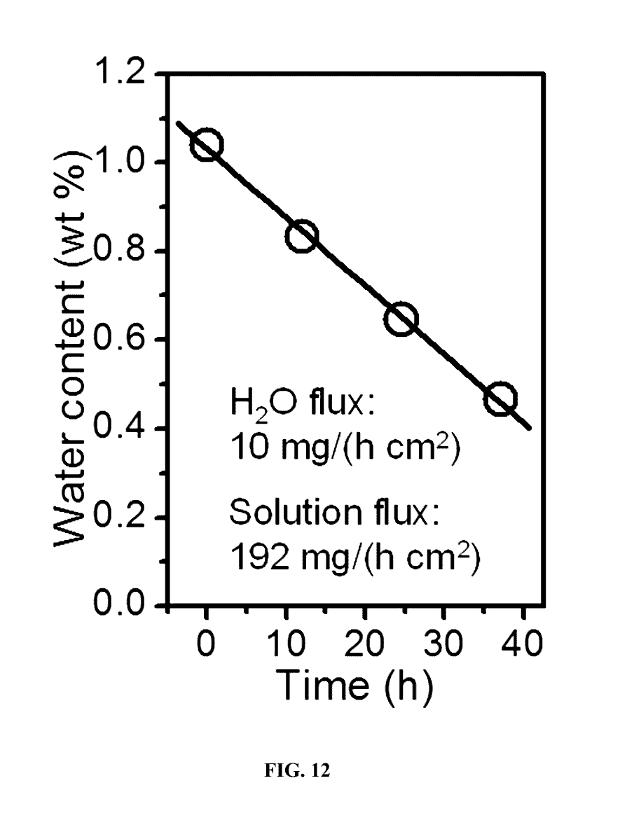

The XL membranes were stable in the pervaporation process and successfully lowered the water content to less than 0.5 wt %. As shown in the graph of FIG. 12, the XL membrane provided high water [10 mg/(h·cm²)] and solution [192 mg/(h·cm²)] fluxes.

In summary, membrane stability can be increased by providing a porous support layer for the membrane, such as a glass fiber or metal grid. The water flux at 100° C. using pervaporation cell configuration B2 and a metal grid support is 6.8 mg/(h·cm²), which is approximately 174% of that produced when employing Celgard® and glass fiber supports. The pervaporation temperature and gas flow rate may be optimized, as higher temperatures and flow rates generally result in larger water and solvent fluxes. These studies show that pervaporation can lower the water content of ionic liquid mixtures from 1 to less than 0.5 wt %.

Various features and advantages of the invention are set forth in the following claims.

1. A pervaporation cell suitable for reducing the water content of a mixture comprising an ionic liquid and water, the cell comprising
i) a liquid chamber having an inlet and an outlet configured to allow a liquid to pass into and out of the liquid chamber;
ii) a gas chamber having an inlet and an outlet configured to allow a gas to pass into and out of the gas chamber; and
iii) a membrane comprising an ionomeric polymer and having a permeation zone,
wherein the membrane separates and partially defines each of the chambers.

2. The pervaporation cell of claim 1, wherein the liquid chamber is at least partially defined by a liquid end plate, and the gas chamber is at least partially defined by a gas end plate, and wherein the membrane is placed between the end plates.

3. The pervaporation cell of claim 2, further comprising a porous support positioned between the membrane and the liquid end plate.

4. The pervaporation cell of claim 1, further comprising at least one gasket.

5. The pervaporation cell of claim 1, wherein the ionomeric polymer comprises a cation-exchange polymer.

6. The pervaporation cell of claim 5, wherein the cation-exchange polymer comprises a sulfonated tetrafluoroethylene-based polymer.

7. The pervaporation cell of claim 1, wherein the mixture further comprises a solvent.

8. The pervaporation cell of claim 1, wherein the membrane has a thickness of between about 0.4 mil and about 10 mil.

9. A method of reducing the water content of a mixture comprising an ionic liquid and water by pervaporation, the method comprising:
a) placing the mixture in the pervaporation cell of claim 1, and
b) pervaporating the ionic liquid mixture to provide a mixture with a total water content equal to or less than about 0.8 wt percent.

10. The method of claim 9, wherein the mixture after pervaporation has a water content equal to or less than about 0.50 wt percent.

11. The method of claim 9, wherein the mixture further comprises a solvent.

12. The method of claim 11, wherein the weight ratio of ionic liquid:solvent is between about 9:1 and about 1:9.

13. The method of claim 9, wherein the ionic liquid comprises a tetraalkylammonium dialkyl phosphate.

14. The method of claim 9, wherein the ionomeric polymer comprises a cation-exchange polymer.

15. The method of claim 14, wherein the cation-exchange polymer comprises a sulfonated tetrafluoroethylene-based polymer.

16. The method of claim 15, wherein the ionomeric polymer comprises a divalent counterion.

17. The method of claim 9, wherein the pervaporation is performed at a temperature of between about 50° C. and about 120° C.

18. The method of claim 9, wherein the water flux through the membrane is at least about 6.0 mg of water per hour cm².
